(19) United States
(12) Patent Application Publication
(10) Pub. No.: US 2026/0225227 A1
(43) Pub. Date: Aug. 6, 2026

(54) SYSTEM AND METHOD FOR CONTAINER MOVING AND ARRANGEMENT

(71) Applicant: Walmart Apollo, LLC, Bentonville, AR (US)

(72) Inventors: Arifa Sultana, Bentonville, AR (US); Huizhi Yi, Pea Ridge, AR (US); Gerald J. Byers, Springfield, MO (US); Michael Jason Klingman, Gentry, AR (US); Tomas A. Blodgett, Fayetteville, AR (US)

(21) Appl. No.: 19/042,147

(22) Filed: Jan. 31, 2025

(51) Int. Cl. B25J 9/00; B25J 9/16

(52) U.S. Cl. CPC B25J 9/0093; B25J 9/1697

(57) ABSTRACT

A system includes a conveyor that moves cases, a robot, a tool disposed at an end of an arm, of the robot, and a sensor. The sensor is positioned to obtain sensed visual information about cases that are located on the conveyor and is controlled by a control circuit. The control circuit receives the sensed visual information from the sensor and processes the sensed visual information to obtain coordinates of a location on a case to contact the case. The coordinates are selected such that damage to the case or contents of the case is prevented when the case is contacted by the tool at the location. The robot then contacts the case with the tool at the coordinates and then to lift and move the case to a selected location.

### TECHNICAL FIELD

This disclosure relates generally to approaches for contacting, moving, and arranging containers.

### BACKGROUND

Cases (e.g., boxes, bins, totes, or other containers) need to be moved and arranged for many purposes. For example, cases that include various types of products may need to be put on a pallet for shipping. The cases may include open top containers or cases (without a lid or cover) and closed-top containers or cases (with a lid or cover). The cases may need to be moved from one area of a store or warehouse to another area of the store or warehouse. In some cases, groups of cases are stacked on pallets so they can be shipped or moved efficiently. Movement of the containers can result in damage to the container or the contents of the container. If assembled on a pallet, the stack of containers on the pallet may (in places) also sag, collapse, or move and these actions may damage the contents of the cases. Open top cases or cases with fragile items are particularly susceptible to damage.

### BRIEF DESCRIPTION OF DRAWINGS

Disclosed herein are embodiments of systems, apparatuses and methods pertaining to contacting, moving, and arranging containers. This description includes drawings, wherein:

FIG. 1 is a block diagram of a system in accordance with some embodiments.

FIG. 2 is a diagram of a system in accordance with several embodiments.

FIG. 3 is diagram of a system in accordance with some embodiments.

FIG. 4 is a flowchart of an approach in accordance with several embodiments.

FIG. 5A is a flowchart of an approach in accordance with some embodiments.

FIG. 5B is a flow part of an approach in accordance with several embodiments.

FIG. 6 is a flowchart of an approach in accordance with some embodiments.

FIG. 7 is a diagram of a result of a system in accordance with several embodiments.

FIG. 8 is a diagram of a result of a system in accordance with some embodiments.

FIG. 9 is a diagram of a result of a system in accordance with several embodiments.

FIG. 10 is a diagram of a result of a system in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein that are useful to contact, move, and arrange cases. These approaches can be implemented and used within retail stores, distribution centers, and warehouses to mention a few examples.

In particular, automated approaches are provided that utilize a robot, a sensor (e.g., a three dimensional (3D) vision camera) for perception and image segmentation, a conveyance system (e.g., that singulates the cases on the conveyor) and a pallet builder algorithm to palletize a wide variety of case types. An image of the case is obtained and the case type and the pick point (one or more areas on the case to be contacted by the robot when moving the case) are identified. The pick point may be one area of the case or multiple areas of the case.

The robot contacts (e.g., grips using a finger gripper tool) the case at the pick point and lifts the case from the conveyor. The robot continues to contact the case and places it precisely and accurately on a pallet using the instructions and/or coordinates from a pallet building algorithm.

In some aspects, accurate placement of the cases that have tabs is validated by the sensing of feedback from the tool (e.g., the tabs are aligned). In some examples the cases are sequenced (e.g., processed and moved in an order determined by a pallet building algorithm) but in other examples these approaches palletize cases on-the-fly as the cases are placed on the conveyor without the cases being sequenced in a predetermined order.

The automated approaches provided herein do not require manually lifting and moving cases. For examples, heavy meat cases, cases with potato sacks, open-top produce containers including fruits or vegetables, and cases with other fragile items are moved and placed on pallets automatically without damaging the cases or the contents of the case. Advantageously, the approaches provided herein detect and account for case tabs leading to precise placement (particularly with open top cases), and significantly reduce or eliminate product damage. Manual intervention in the process is also avoided, thereby reducing labor costs.

In many of these embodiments, a system comprises a conveyor, a robot, a tool disposed at the end of the arm, and a sensor. The conveyor moves cases, and the cases contain consumer products. The cases also include at least some open-top cases.

The robot has an arm, and the robot is operated and controlled by a first control circuit. The tool is disposed at an end portion of the arm, and the tool when actuated to remove the cases on the conveyor. The sensor is positioned to obtain sensed visual information about the cases that are located on the conveyor. The sensor is operated and controlled by a second control circuit.

The second control circuit receives the sensed visual information from the sensor; processes the sensed visual information to obtain coordinates of a location on a case to contact the case such that damage to the case or contents of the case is prevented when the case is contacted by the tool at the location. The location on a closed-top case comprises a top surface of the closed-top case, and the location on an open-top case comprises a first location on a first side of the open-top case and a second location on a second side of the open-top case. The second side opposes the first side. The second control circuit transforms the coordinates from a first frame of reference of the sensor to a second frame of reference of the robot and sends the transformed coordinates to the first control circuit instructing the robot to contact the case according to the coordinates;

The first control circuit responsively controls the robot to precisely contact the case with the tool at the transformed coordinates and then to lift and move the case to a selected location on a pallet. The selected location on the pallet is determined by a selection algorithm so as to not damage the case or the contents of the case after the case is placed on the pallet.

In aspects, the second control circuit processes the sensed visual information by obtaining a three dimensional (3D) point cloud, converting the 3D point cloud into a depth map for a region of interest on the case that includes the case, performing image segmentation using the depth map to isolate the case, and determining contours of the case, a pose of the case, and dimensions of the case based upon the segmented image. In other aspects, subsequent to sending the transformed coordinates the robot sends an electronic acknowledgement to the sensor, which responsively causes the sensor to prepare to capture information concerning a next case on the conveyor.

In other examples, the selection algorithm determines locations for stacking based on alignment tabs and corresponding alignment openings of the cases. In some examples, the selection algorithm utilizes a list of items to be included on the pallet, case dimensions, and case types to determine the selected location on the pallet. In other examples, the selection algorithm determines an orientation of each case on the pallet, a position of each case on the pallet, and whether a slip sheet is required for the pallet.

In some example, the sensor is a camera, and the camera is a three dimensional (3D) vision camera. Other examples are possible.

In other examples, the second control circuit processes the sensed visual information by combining two dimensional (2D) red, green, blue (RGB) data and depth data. Other examples are possible.

In other aspects, image segmentation is performed by the second control circuit using a segment anything model (SAM) algorithm. In still other examples, the coordinates are sent to the robot via Open Platform Communications Unified Architecture (OPC-UA) Protocol. Other examples are possible.

In others of these embodiments, cases are moved using a conveyor. The cases contain consumer products, and the cases include at least some open-top cases. A robot is operated using a first control circuit, the robot having an arm and a tool disposed at an end portion of the arm, the tool when actuated to remove the cases on the conveyor.

Sensed visual information is obtained about the cases that are located on the conveyor using a sensor. The sensor is operated and controlled by a second control circuit.

The second control circuit receives the sensed visual information from the sensor; processes the sensed visual information to obtain coordinates of a location on a case to contact the case such that damage to the case or contents of the case is prevented when the case is contacted at the location. The location on a closed-top case comprises a top surface of the closed-top case, and the location on an open-top case comprises a first location on a first side of the open-top case and a second location on a second side of the open-top case. The second side opposes the first side.

The second control circuit transforms the coordinates from a first frame of reference of the sensor to a second frame of reference of the robot; and sends the transformed coordinates to the first control circuit instructing the robot to contact the case according to the coordinates;

The first control circuit responsively controls the robot to precisely contact the case with the tool at the transformed coordinates and then to lift and move the case to a selected location on a pallet. The selected location on the pallet is determined by a selection algorithm so as to not damage the case or the contents of the case after the case is placed on the pallet.

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

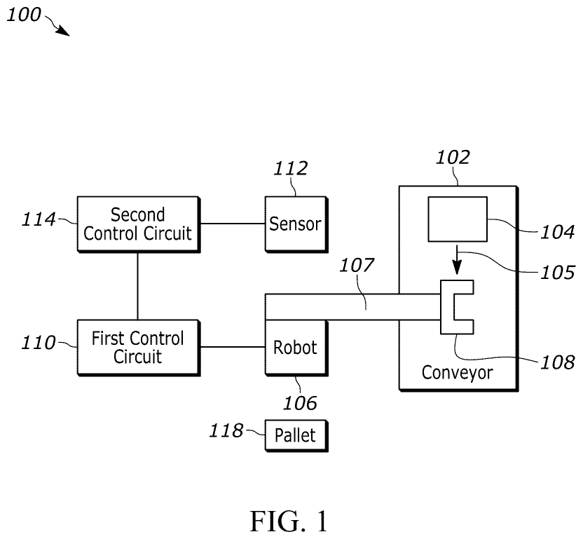

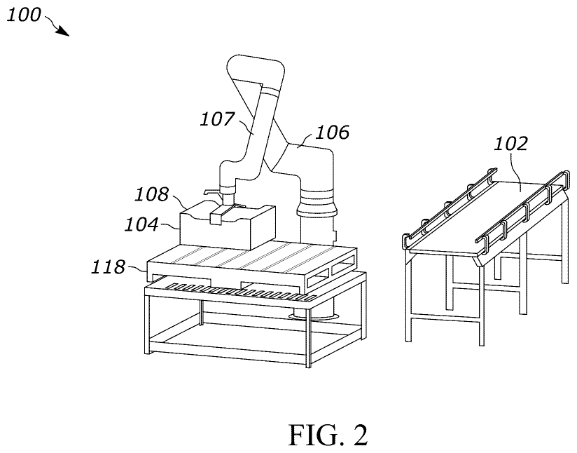

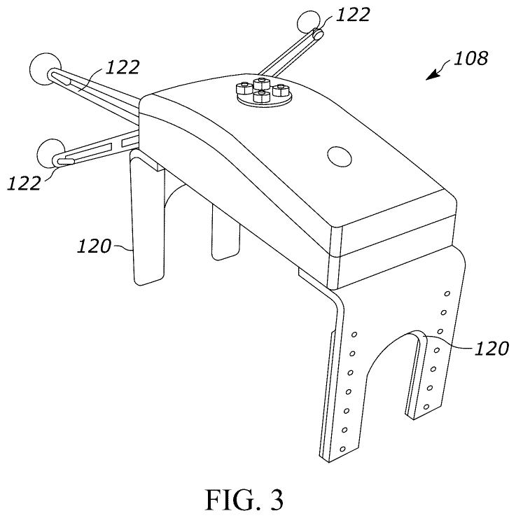

Referring now to FIG. 1, FIG. 2, and FIG. 3, one example of a system 100 that contacts, moves, and arranges cases is described. The system 100 includes a conveyor 102, a case 104 (moving along the conveyor 102 in the direction of the arrow labeled 105), a robot 106, an arm 107 of the robot 106 with a tool 108 at the end of the arm 107, a first control circuit 110, a sensor 112, a second control circuit 114, and a pallet 118.

The conveyor 102 is a mechanism that transports objects from one location to another location in accordance with some embodiments. Examples of suitable conveyors 102 include belt conveyors, chain conveyors, roller conveyors, overhead conveyors, and so forth. In some embodiments, the conveyor 102 transports cases 104 from a first location towards the robot 106. In some aspects, cases 104 are placed onto the conveyor 102 manually by an operator (e.g., a human individual and/or robotic operator). In some embodiments, the conveyor 102 is connected to additional conveyors 102 and/or mechanisms, and cases 104 are transferred from an upstream conveyor/mechanism to the conveyor 102. In some forms, cases 104 are randomly placed onto the conveyor 102 (i.e., without any sequence to the placement, e.g., based on the order that the cases 104 arrive at the conveyor 102), and the layout of the cases 104 on the pallet 118 is determined without pre-sequencing of cases 104. In some forms, cases 104 are sequentially placed onto the conveyor 102 (e.g., in a specific order for pallet building). In some aspects, a selection algorithm (i.e., a pallet building algorithm) determines the order in which cases 104 are to be placed onto a pallet 118 and, consequently, on the conveyor 102.

The case 104 is a container containing any suitable items (e.g., retail items, supplies, consumer products, etc.) in accordance with some embodiments. For example, the cases 104 may be any container, box, tote, package suitable for holding items. In some aspects, the cases 104 described are generally rectangular cases, however, it is understood that the dimensions of the cases 104 may be any suitable dimensions such that a case 104 is able to be interacted with by the robot 106 (i.e., a size and shape that can be gripped by the end of arm 107 tool 108 of the robot 106). In some embodiments, the cases 104 are closed-top cases with no exposed sides (e.g., a box having 6 enclosed sides). In some embodiments, a case 104 may be an open-top case with one exposed side.

Open-top cases generally have a bottom joined with four perpendicular sides to enclose and/or hold items within the case 104, and an exposed top. Generally, open-top cases have tabs protruding upwards from one or more sides (e.g., at least one tab on opposite sides), and corresponding slots on the bottom of the open-top case. For example, tabs of a first open top case may be inserted into the corresponding slots of an open-top case stacked on top of the first open-top case. By inserting the tabs into corresponding slots, open-top cases are able to be stacked with increased stability. In some embodiments, the conveyor 102 moves cases 104 containing consumer products, the cases 104 including at least some open-top cases.

The robot 106 is generally a controllable machine for executing various actions in accordance with some embodiments. In some embodiments, the robot 106 includes an arm 107. The robot 106 is operable and controlled by electronic control signals from the first control circuit 110 described herein. In the present example, the robot 106 is an articulated robot (e.g., with six-axes of mobility) with connected joints able to move with various degrees of freedom (e.g., vertical movement, horizontal movement, rotational movement, etc., and any combination thereof). Any alternate suitable type of robot 106 may be used (e.g., cartesian robots, SCARA robots, delta robots, and so forth). In one example, the robot 106 picks a case 104 using a tool 108 in the form of a finger gripper, and places it precisely and accurately on the pallet 118 using information received from, for example, a pallet building and/or selection algorithm.

The arm 107 is generally a mechanical arm mounted to and moveable about a base in accordance with some embodiments. Generally, the arm 107 includes at least two sections (i.e., mimicking a human arm with an upper arm and a forearm). In some embodiments, the arm 107 is moveable in multiple degrees of freedom (e.g., a 6-axis robotic arm has 6 degrees of freedom). Generally, degrees of freedom refers to translational movement (i.e., linear movement along an axis) and/or rotational movement (i.e., movement around an axis) of portions of the arm 107 relative to one another. For example, a joint (i.e., a connector between sections of an arm 107) may have multiple degrees of freedom and be moveable along and/or around multiple axis. FIG. 2 shows an arm 107 including a first distinct section mounted to a base adjacent to a conveyor 102, and a second distinct section moveable relative to the first distinct section. A tool 108 may further be mounted to a distal end of the second distinct section. In one example, the first distinct section may be moveable relative to the base, the second distinct section may be moveable relative to the first distinct section, and the tool 108 may be moveable relative to the second distinct section. An arm 107 may have any number of sections (e.g., one, two, three, and so forth) of any shape (e.g., curved, straight, tapered, etc.) and size.

The tool 108 is attached to the arm 107 of the robot 106 in accordance with some embodiments. Generally, the tool 108 performs various actions (e.g., suction, pinching, cradling, etc.) on objects. In some aspects, the tool 108 is disposed at an end portion of the arm 107 and, when actuated, removes cases 104 that are located on the conveyor 102. In some embodiments, as shown in FIG. 3, the tool 108 is a gripper tool with more than one gripper 120 to grip/pinch an object. A gripper 120 (which may also be referred to as a finger, member, and so forth) may have multiple degrees of freedom in order to contact and grip an object. In some aspects, the tool 108 is a suction tool which suctions (e.g., by physical suction elements, air suction, vacuum, etc.) an object. In some embodiments, the tool 108 is interchangeable from the arm 107 and/or robot 106. Additionally, tools 108 with able to contact an object in a specific way may be better suited for certain scenarios and/or objects and may be interchanged accordingly. For example, cases 104 with closed tops may be engaged with by a suction tool (i.e., to suction the top of the case 104) and/or a gripper tool (i.e., to engage with sides of the case 104). In another example, cases 104 with open tops and may be engaged with a gripper tool (i.e., to engage with sides of the case 104 since the top is exposed). In other words, a closed top case is generally engageable from a top surface and/or side surfaces, and an open top case is generally engageable from side surfaces and not a top surface.

Contact of a tool 108 with an object and/or case may include pinching, suctioning, grasping, gripping, cradling, and so forth. The tool 108 may further include a sensor 122. The sensor(s) 122 (e.g., proximity sensor, potentiometer, ultrasonic sensor, visual sensor, and so forth) may validate the location of a case 104 (particularly of an open-top case having tabs) after being placed onto the pallet 118. In some embodiments, sensed information from the sensor(s) 122 indicating that a case 104 has been accurately placed on the pallet 118 is sent to the first control circuit 110 and/or the second control circuit 114.

The first control circuit 110 and second control circuit 114 may include any suitable processing resource configured to execute instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The first control circuit 110, second control circuit 114, or controller may be configured (for example, by using corresponding programming stored in a memory as will be well understood by those skilled in the art) to carry out one or more of the steps, actions, and/or functions described herein. In some embodiments, the first control circuit 110 and/or the second control circuit 114 are cooperated with (e.g., over a network) any suitable machine learning models (e.g., computer vision models) in order to perform the steps, actions, and/or functions described herein. The first control circuit 110, the second control circuit 114, and/or any additional control circuits may run in parallel with one another such that multiple steps, actions, and/or functions are executed simultaneously. In some embodiments, the first control circuit 110 and/or the second control circuit 114 may be located locally within the system 100 (e.g., at the robot 106, the sensor 112, etc.). In some aspects, the first control circuit 110 and/or the second control circuit 114 are located remotely relative to the system 100 (e.g., from a personal computer, laptop, external computing device, etc.).

In some embodiments, the second control circuit 114 determines how the robot 106 should contact/engage with a case 104 in order to be placed on a pallet 118. In some embodiments, the first control circuit 110 controls movement of the robot 106. In some examples, the first control circuit 110 responsively controls the robot 106 to contact a case 104 with the tool 108 based on transformed coordinates sent to the first control circuit 110 by the case 104. In some embodiments, the second control circuit 114 controls movement of the conveyor 102. For example, in response to a case 104 being placed onto a pallet 118, the second control circuit 114 may actuate the conveyor 102 to bring another case 104 adjacent the robot 106. In some aspects, sensed information from the sensor(s) 122 of the tool 108 may indicate that a case 104 has been accurately placed on a pallet 118 and cause the second control circuit 114 to actuate the conveyor 102.

The sensor 112 detects and/or measures a physical stimulus/property in accordance with some embodiments. In the present disclosure, the sensor 112 generally refers to a visual sensor (e.g., a camera) which captures sensed visual information (e.g., images and/or videos). A camera generally captures images and/or video with a specific field of view. In some embodiments, the sensor 112 is placed such that the field of view of the sensor 112 encompasses cases 104 located on the conveyor 102. The sensor 112 may be any suitable camera (e.g., fixed, non-fixed) with any suitable field of view (e.g., fixed, variable), and the sensed visual information may include two dimensional (2D) images, three dimensional (3D) images, videos, and so forth. In some embodiments, the sensor 112 is a camera, and the camera is a three dimensional (3D) vision camera which captures 3D images. In one example, the sensor 112 is a camera for 3D imaging and depth data acquisition.

The pallet 118 is a platform for handling, storing, and/or moving objects in accordance with some embodiments. In some aspects, the pallet 118 is a platform engageable (e.g., by a forklift) in order to move the pallet 118 and objects/cases 104 stacked thereon. A pallet 118 may include a plurality of wooden slats, however, it is generally contemplated that any alternate material can be used. While the present embodiment described a pallet 118 as a physical platform, it is generally contemplated that in some embodiments a pallet 118 is any location or structure (e.g., movable and/or stationary) which a pile of cases 104 may be built.

In one example, of the operation of the system 100 of FIG. 1 and FIG. 2, the case 104 moves using the conveyor 102 in the direction indicated by the arrow 105. Generally, cases 104 are moved/transported on the conveyor 102 in a direction (as indicated by the arrow 105) that is towards the robot 106. The case 104 may be an open-top case, that is, and not have a lid or other surface on the top of the case 104. The robot 106 is operated using the first control circuit 110. The first control circuit 110 controls the movement and operation of the arm 107 and the tool 108.

The sensor 112 obtains sensed visual information concerning the case 104. For example, the sensor 112 may be a camera that obtains visual images of the case 104. In some embodiments, the sensor 112 continuously monitors the conveyor 102 and cases 104 thereon, while in some aspects the sensor 112 captures/obtains visual images in response to an indication (e.g., from a control circuit or processor), for example, that a previous case 104 has been placed onto the pallet 118 and that a new case 104 is being transported on the conveyor 102.

The second control circuit 114 operates and/or controls the sensor 112. For example, the second control circuit 114 instructs the sensor 112 to obtain images. The second control circuit 114 also communicates with and/or receives communications from the first control circuit 110. For example, when the first control circuit 110 finishes processing and image, or finishes moving the case 104, then the first control circuit 110 sends a signal to the second control circuit 114 to cause the sensor 112 to take the next image. There may be any additional sensors (e.g., visual sensors, proximity sensors, ultrasonic sensors, and so forth) to determine that a case 104 has been moved from the conveyor 102 and/or placed onto the pallet 118 and consequently signal the first control circuit 110 and/or the second control circuit 114 to cause the sensor 112 to take the next image. In some embodiments, a motion sensor adjacent the conveyor 102 may detect movement of a subsequent case 104 on the conveyor 102 and signal the first control circuit 110 and/or the second control circuit 114 to cause the sensor 112 to capture the next image.

The second control circuit 114 receives the sensed visual information from the sensor 112 and then processes the sensed visual information to obtain coordinates of a location on a case to contact the case. The location is selected such that damage to the case or contents of the case is prevented when the case is contacted at the location. In aspects, the location on a closed-top case comprises a top surface of the closed-top case (e.g., to be suctioned by a tool 108 in the form of a suction tool), and the location on an open-top case comprises a first location on a first side of the open-top case and a second location on a second side of the open-top case. The second side opposes the first side (e.g., to be gripped by a tool 108 in the form of a gripper tool). In some aspects, a closed-top case may alternately be contacted at a first location on a first side of the closed-top case and a second location on a second side of the closed-top case (e.g., to be gripped by a tool 108 in the form of a gripper tool). In other examples, the location may be selected according to areas selected on similar cases, areas of the case without any openings, the thickest areas of the case, predetermined areas (e.g., the middle) of the case, or areas of the case with certain markings. Other examples are possible.

In some embodiments, the second control circuit 114 processes the sensed visual information by: obtaining a three dimensional (3D) point cloud, converting the 3D point cloud into a two dimensional (2D) depth map, performing image segmentation using the depth map to isolate the case, and using the segmented image to determine, for example, contours of the case, a pose of the case, and dimensions of the case. In some aspects, the image segmentation is performed by the second control circuit 114 using a segment anything model (SAM) algorithm. The SAM algorithm generally works by generating one-time image embeddings (e.g., for an image taken by the sensor 112) with an image encoder, embedding prompts (e.g., isolate a case 104) with a prompt encoder, and combining the one-time image embeddings and the prompt embeddings with a lightweight mask decoder in order to generate a mask (e.g., a separate image which excludes specific pixels from the original image). When applied to an image, the mask allows the contours, pose, and dimensions of the case 104 to be determined for precise handling. In some embodiments, the second control circuit 114 processes the sensed visual information by combining two dimensional (2D) red, green, blue (RGB) data and depth data (e.g., from a depth map).

The second control circuit 114 transforms the coordinates from a first frame of reference of the sensor 112 to a second frame of reference of the robot 106. For example, the sensor 112 may have its own (x, y, z) coordinate system and the robot 106 has its own (x, y, z) coordinate system and the coordinates do not correspond. In some aspects, once a pose of a case 104 is calculated, it is transformed from the frame of reference of the sensor 112 to the frame of reference of the robot 106 using a hand-eye calibration process in a robot operating system (ROS) of the robot 106.

The second control circuit 114 then sends the transformed coordinates to the first control circuit 110 instructing the robot 106 to contact the case 104 according to or at the transformed coordinates. In some embodiments, the coordinates are sent to the robot 106 via Open Platform Communication Unified Architecture (OPC-UA) Protocol, which is generally used to enable communication between devices (e.g., the robot 106, the sensor 112, the first control circuit 110, the second control circuit 114, the sensor(s) 122, and so forth). Other types of protocols can also be used. In some aspects, subsequent to sending the transformed coordinates, the robot 106 sends an electronic acknowledgment to the sensor 112 which responsively causes the sensor 112 to prepare capture information concerning a next case 104 on the conveyor 102. In some embodiments, communication between the components of the system 100 is managed by an additional control circuit and/or processor.

The first control circuit 110 responsively controls the robot 106 to precisely contact the case with the tool 108 at the transformed coordinates and then to lift and move the case to a selected location on the pallet 118. For example, when the tool 108 is a gripper tool having a claw or finger arrangement (e.g., grippers 120) which contacts at least two sides of a case 104, the force applied by the grippers 120 inwardly on the case 104 allows the case 104 to be lifted and moved. Generally, grippers 120 contact at least one pair of opposite sides of a case 104 (that is not the top and bottom) in the generally middle of each side. In another example, when the tool 108 is a suction tool having a suction cup or vacuum arrangement, which contacts at least one side of a case 104, a suction force applied outwardly on the case 104 allows the case 104 to be lifted and moved. Generally, a suction component contacts a top surface of a case 104 (i.e., a closed-top case) generally in the middle of the surface. In some aspects, a case 104 is contacted generally in the center of a respective side of the case 104 for handling.

As mentioned, the selected location on the pallet 118 is determined by a selection algorithm so as to not damage the case or the contents of the case after the case is placed on the pallet 118. For example, the case 104 may be an open-top case and the targeted location for gripping the case 104 may be side areas of the case 104 that are known to be strong and provide the greatest amount of stability when the case 104 is gripped at this location, lifted, and moved. An open-top case may, for example, be lifted by a tool 108 that is a gripper tool. For example, a case 104 may be a closed-top case and the targeted location for gripping the case 104 may be the sides (e.g., when the tool 108 is a gripper tool) or a top surface (e.g., when the tool 108 is a suction tool). The selected location on the pallet 118 may be determined relative to the type of tool 108 attached to the arm 107 of the robot 106 at a given point in time.

The case 104 is placed on the pallet 118. As shown in FIG. 3, the tool 108 may include sensors (e.g., cameras) 122. In some embodiments, the sensor(s) 122 of the tool 108 determine the positioning and/or location of the case 104 relative to the pallet 118. The sensor(s) 122 may validate placement of a case 104 and/or may provide continual feedback to assist in the placement of a case 104 on the pallet 118. In some embodiments, there may be any additional sensor(s) (e.g., proximity sensor, potentiometer, ultrasonic sensor, visual sensor, and so forth) located on and/or adjacent to a pallet 118 in order to verify the placement of a case 104 on the pallet 118. The sensor(s) on and/or adjacent to a pallet 118 may validate placement of a case 104 and/or may provide continual feedback to assist in the placement of a case 104 on the pallet 118. In some embodiments, sensor(s) 122 on the tool 108 and/or additional sensors on and/or adjacent a pallet 118 may be used to determine (in conjunction with the first control circuit 110 and/or any additional or alternate control circuits) if tabs (e.g., on an open-top case) are aligned with corresponding tabs on a case 104 below (i.e., the tabs of a bottom open-top case will insert into corresponding slots/alignment openings of an open-top case being placed by the robot 106). In some embodiments, the selection algorithm determines the location to stack cases 104 based on alignment tabs and corresponding alignment openings of the cases 104. In some aspects, the selection algorithm utilizes a list of items to be included on the pallet 118, dimensions (e.g., height, width, length, shape, etc.) of a case 104, a position of each case 104 on the pallet 118, and/or whether a slip sheet (e.g., to be placed beneath cases 104 on the pallet 118 to allow the stacked cases 104 to be easily moved onto/off of the pallet 118) is required for the pallet.

Referring now especially to FIG. 3, one example of a tool 108 with a finger gripper and/or gripper tool is described. Generally, a gripper tool includes at least two grippers 120 configured to move with multiple degrees of freedom. For example, the grippers 120 may extend outwardly (relative to a side of a case 104) as the tool 108 is brought adjacent to a case 104, and the grippers 120 may retract inwardly (relative to a side of the case 104) in order to contact and apply pressure onto a respective side of a case 104. In the shown embodiment, the tool 108 includes two grippers 120 which contact opposite sides of a case 104, however, it is contemplated that some embodiments include alternate numbers of grippers 120 (e.g., three, four, etc.) in order to contact and apply pressure (i.e., pinch) onto additional sides of a case 104. Generally, at least two grippers 120 relative opposite sides of a case 104 are required (i.e., opposing forces inwards on the case 104 to allow the case 104 to be lifted and not pushed). In alternate embodiments, the tool 108 may be a suction tool (e.g., with suction cups, air suction, vacuums, etc.), a cradling tool (e.g., with a surface which holds a case 104 from a bottom surface), and so forth such that a case 104 is lifted and moved.

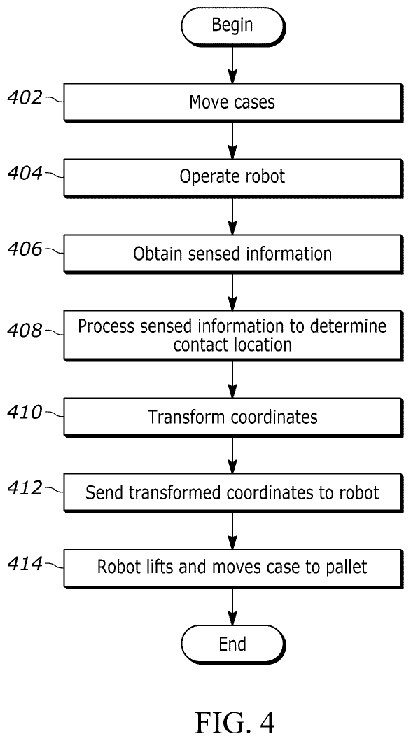

Referring now to FIG. 4, one example of an approach for contacting, moving, and arranging cases is described. In some embodiments, the approach described relative to FIG. 4 utilizes the system 100 and/or components of the system 100.

At step 402, cases are moved using a conveyor. The cases contain consumer products, and the cases include at least some open-top cases (e.g., cases with an exposed top). Open-top cases generally include tabs which when aligned, may be inserted into respective alignment openings of an open-top case being placed on top of a bottom open-top case. The cases may also include closed-top cases with no exposed sides. Generally, the cases are moved in a direction towards a robot. In some embodiments, the conveyor continuously moves, while in some embodiments, the conveyor stops when a case is adjacent to the robot.

At step 404, the robot is operated using a first control circuit, the robot having an arm and a tool disposed at an end portion of the arm, the tool when actuated to remove the cases on the conveyor. The robot and arm generally are moveable with various degrees of freedom. For example, the robot may be a 6-axis robot which moves with six degrees of freedom. The arm generally includes at least a first section and a second section moveable relative to one another. The tool is disposed at an end portion of the arm and may further be moveable with multiple degrees of freedom. In one example, the tool is a gripper tool which pinches/grasps a case, while in another example the tool is a suction tool which suctions a case.

At step 406, sensed visual information is obtained about the cases that are located on the conveyor using a sensor. The sensor is operated and controlled by a second control circuit. The sensor, in some embodiments, is a camera, and the sensed visual information is a 3D image taken of a case located on a conveyor. In some aspects, the sensor is a camera, and the camera is a three dimensional (3D) vision camera.

At step 408, the sensed visual information is processed. In these regards, the second control circuit receives the sensed visual information from the sensor; processes the sensed visual information to obtain coordinates of a location on a case to contact the case such that damage to the case or contents of the case is prevented when the case is contacted at the location. For example, an open-top case and/or a closed-top case may be contacted at a first location on a first side of the open-top case and a second location on a second side of the open-top case, the second side opposing the first side. A closed-top case may further be contacted on a top-surface of the closed-top case. The processing may further include: obtaining a three dimensional (3D) point cloud, converting the 3D point cloud into a depth map for a region of interest on the case that includes the case, performing image segmentation using the depth map to isolate the case, and determining contours of the case, a pose of the case, and dimensions of the case based upon the segmented image. In some aspects, the image segmentation is performed by the second control circuit using a segment anything model (SAM) algorithm. In some embodiments, the processing includes combining two dimensional (2D) red, green, blue (RGB) data and depth data.

As mentioned the coordinates of the case for robot contact are determined by analyzing the data obtained from the image. For example, the location may be selected according to areas selected on similar cases (that have been previously processed), areas of the case without any openings, the thickest areas of the case, predetermined areas (e.g., the middle) of the case, or areas of the case with certain markings. These areas may be selected because they are known or have otherwise been determined to be the strongest areas of the case and/or promote the greatest amount of stability when the case is moved. Other examples of factors for area selection are possible.

At step 410, the second control circuit transforms the coordinates from a first frame of reference of the sensor to a second frame of reference of the robot. For example, the sensor may have its own (x, y, z) coordinate system and the robot has its own (x, y, z) coordinate system and the coordinates do not correspond. In other words, the coordinates system of the sensor is transformed such that the coordinates align with the coordinate system of the robot.

At step 412, the second control circuit sends the transformed coordinates to the first control circuit instructing the robot to contact the case according to the coordinates. In some aspects, subsequent to sending the transformed coordinates, the robot sends an electronic acknowledgement to the sensor, which responsively causes the sensor to prepare to capture information concerning a next case on the conveyor. In some aspects, the coordinates are sent to the robot via Open Platform Communications Unified Architecture (OPC-UA) Protocol. Other examples are possible.

At step 414, the first control circuit responsively controls the robot to precisely contact the case with the tool at the transformed coordinates and then to lift and move the case to a selected location on a pallet. The selected location on the pallet is determined by a selection algorithm so as to not damage the case or the contents of the case after the case is placed on the pallet. In some examples, the selection algorithm determines locations for stacking based on alignment tabs and corresponding alignment openings of the cases. In some aspects, the selection algorithm utilizes a list of items to be included on the pallet, case dimensions, and case types to determine the selected location on the pallet. In some embodiments, the selection algorithm determines an orientation of each case on the pallet, a position of each case on the pallet, and whether a slip sheet is required for the pallet.

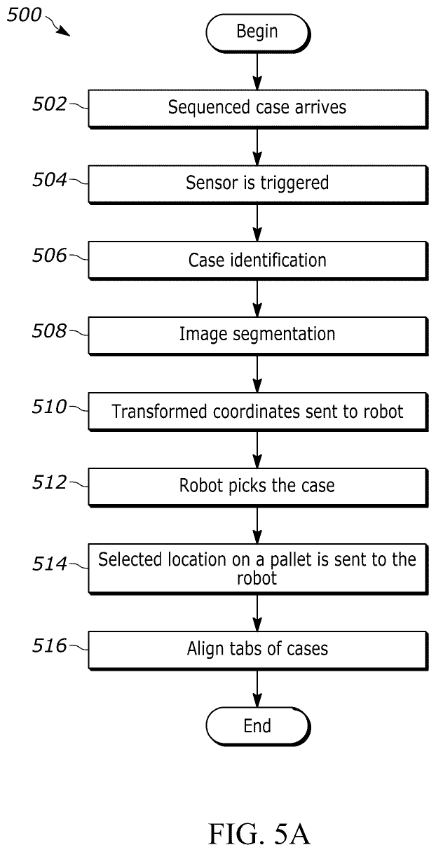

Referring now to FIGS. 5A and 5B, one example of an approach for contacting, moving, and arranging cases is described. In some embodiments, the approach described relative to FIGS. 5A and 5B utilizes the system 100 and/or components of the system 100. In some embodiments, it is contemplated that the approach described in FIGS. 5A and 5B may be the same and/or similar to the approach described in FIG. 4.

At step 502, sequenced cases arrive at a robot via a conveyor. In some aspects, the cases arriving are pre-sequenced (e.g., by a pallet building algorithm) for placement onto a pallet. In alternate embodiments, cases arrive at the robot in a randomized order corresponding with an order in which the cases were placed onto the conveyor upstream of the robot.

At step 504, a sensor adjacent to the robot is triggered in response to the arrival of a case. The triggering of the sensor causes the sensor to capture sensed visual information. Generally, the sensor is a camera (e.g., a 3D camera), and the sensed visual information is an image (e.g., a 3D image) of the case.

At step 506, the case adjacent to the robot is identified from the image taken by the sensor. Identification of a case may, in some aspects, be identification of the presence of the case. In some embodiments, identification of a case may be identification of a barcode or identifier on the case which indicates, for example, a type of item within the case, weight of the case, and so forth.

At step 508, image segmentation is performed on the image taken. In one example, a segment anything model (SAM) may be used to perform image segmentation. Further referring to FIG. 5B, the image segmentation may further include the following steps. At step 518, sensed visual information (e.g., the 3D image) is broken into a 3D point cloud. At step 520, the 3D point cloud is converted into a depth map. At step 522, the depth map is broken into individual pixels. At step 524, pixels indicating a depth above a certain depth (e.g., the height of the conveyor) are secluded to isolate the case. At step 526, the segmented image is used to determine contours of the case, a pose of the case, and dimensions of the case. The determined information is used to determine coordinates (e.g., in a first frame of reference of the sensor) of a location on the case (e.g., at which the robot is to contact the case) that are then transformed into a second frame of reference of the robot.

In aspects, the determined information I used to determine the strongest area of the case for gripping. For example, the middle of the top of the case may be known or determined to be the strongest area of the case. The coordinates of the middle of the case are determined using the determined information.

At step 510, transformed coordinates are determined and sent to the robot. As mentioned, the coordinates are initially in the coordinate system of the sensor but these are transformed to the coordinate system of the robot. The transformed coordinates indicate a location on the case that an end of arm tool of the robot will contact in order to pick the case and are in the coordinate system of the robot. For example, for an open-top case and/or a closed-top case, the location indicated in the coordinates may include a first location on a first side of the open-top case and a second location on a second side of the open-top case, the second side opposing the first side. For a closed-top case, the location indicated in the coordinates may alternately be a top surface of the closed-top case.

At step 512, the robot picks the case at the transformed coordinates. In some aspects, a tool disposed at the end of an arm of the robot contacts and picks the case. In one example, the tool may be a gripper tool which contacts (e.g., by pinching/grasping) a first and second location of an open-top case or a closed-top case as described herein. In another example, the tool may be a suction tool which contacts (e.g., by suction) a top-surface of a closed-top case. After being contacted, the case is lifted from the conveyor by the robot.

At step 514, a selected location on a pallet is sent to the robot. In some examples, a selection and/or pallet building algorithm is used to determine the selected location. Generally, the selected location is determined such that the case and/or the contents of the case are not damaged during and/or after the case is placed onto the pallet. For example, the selected location may delegate heavier cases to the bottom of the pallet, cases of the same height to be placed side-by-side, and tabs of open-top cases to be aligned with corresponding alignment openings/slots.

At step 516, tabs of cases are aligned as the case is placed onto the pallet. In aspects, aligning the tabs of adjacent cases increases the stability of the cases on the pallet.

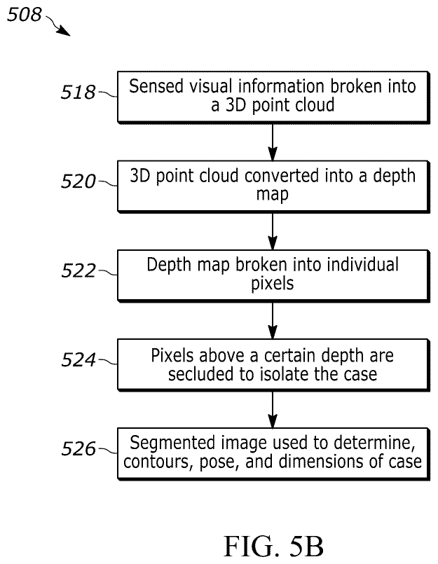

Referring now to FIG. 6, one example of a pallet building and/or selection algorithm is described. The algorithm described may be used with the system 100, components of the system 100, and/or the approaches for contacting, moving, and arranging cases described herein. This algorithm may be deployed and executed at the control circuits described herein or at a separate control circuit (with the results of the execution of the algorithm being sent to the first control circuit described herein).

At step 602, information regarding the cases to be stacked is received. For example, the information may include a list of the items/cases to be picked, a picking quantity (i.e., the number of cases to be picked), an order of picking, and/or case dimensions. In some embodiments, the case dimensions includes information regarding the type of case being picked (i.e., if the case is a closed-top case or an open-top case). In some aspects, the order of picking is based on an order of arrival of cases at robot doing the picking. In some embodiments, the pallet building algorithm further determines the order of picking based on the received information and determines an order of picking which increases stability of the stacked cases on the pallet. Using the determined order of picking, the robot moves the cases to the pallet. The information may further include a weight of a case, an evenness of surfaces of a case, type of items within a case (e.g., if an item is fragile), and so forth.

At step 604, the pallet building algorithm determines a pallet layout based on the information received. The layout may follow certain constraints which include, for example, physical boundaries of the pallet (e.g., cases not being placed off of an edge of a pallet or being stacked too high on the pallet). The layout may further aim to increase pallet stability by taking into account case height (e.g., cases of the same height may be placed in the same row as each other) and case evenness (e.g., cases with uneven surfaces may be placed on top of a stack rather than at the base of the stack). The layout may further aim to minimize air gaps between cases and ensure that tabs of open-top cases are aligned with corresponding alignment openings/slots of stacked open-top cases. Further, depending on the destination of the stack of cases, the pallet builder algorithm may determine if a slip sheet is required before cases are stacked (e.g., to allow a stack of cases to be easily removed from a pallet).

At step 606, the pallet layout is output to a robot. The pallet layout includes the orientation (e.g., an open-top case being required to have the exposed side facing upwards, a long of a case being along the X-axis rather than the Y-axis, etc.) of each case on the pallet, the physical location of the case (e.g., in X, Y, Z coordinates), and whether or not a slip sheet is to be used. Generally, the layout is output to the robot, and the robot picks the cases (e.g., off of a conveyor) and moves the cases to the indicated location on the pallet in the indicated order of picking.

In one example, six cases (C1, C2, C3, C4, C5, and C6) are analyzed by the pallet building algorithm to determine the most stable arrangement of the cases on a pallet. For example, cases C1 and C2 are relatively heavy, and are closed-top cased. Cases C3, C4, C5, and C5 are comparatively light, and are open-top cases. The pallet building algorithm may determine that a stable arrangement of the cases includes placing the closed-top cases C1, C2 side-by-side on the bottom of the pallet, stacking one open-top case on top of either closed-top case (e.g., C3 on top of C1 and C4 on top of C2), and aligning and stacking the remaining open-top cases C5, C6 on top of C3 and C4, respectively. The pallet building algorithm may describe a sequence (order) of cases and the robot moves the cases according to the sequence.

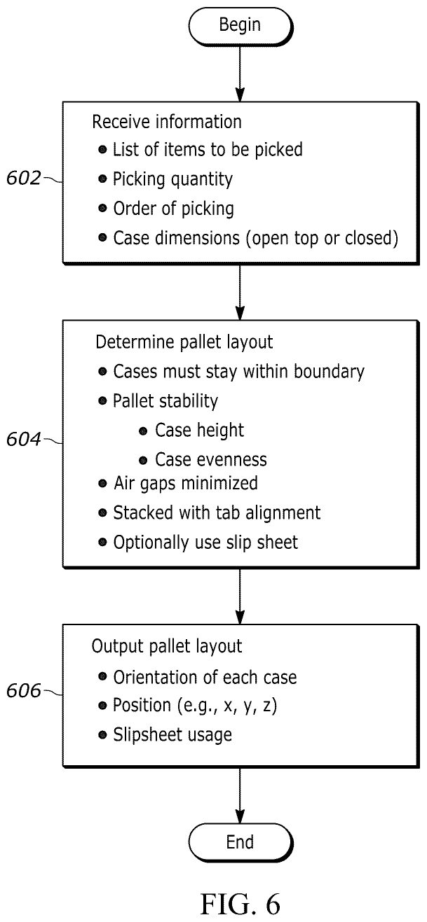

Referring now to FIG. 7, an example of a pallet 718 with multiple open-top cases 704 is shown. The cases 704 are stacked such that tabs of the cases 704 align with alignment openings on corresponding cases 704 placed above. As shown, the cases 704 are placed within the bounds of the pallet 718, and the height of the stacked cases does not exceed a maximum height. The specific placement of the cases 704 may have been determined by a selection and/or pallet building algorithm. The placement of cases 704 on the pallet 718 (including the alignment of tabs (not shown)) increases the stability of the cases 704 on the pallet 718.

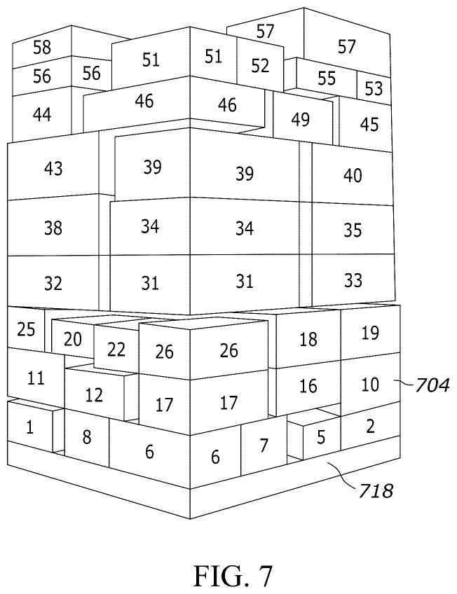

Referring now to FIG. 8, another example of a pallet 818 with multiple closed-top cases 804 is shown. The cases 804 are placed in the sequence indicated by the numbering (e.g., 1, 2, 3, 4, 5, and so on) labeled on the cases 804. The sequencing may be determined by a selection and/or pallet building algorithm in order to increase stability of the cases 804 on the pallet 818. For example, cases 804 of similar heights may be placed next to one another in order to create an even row of cases 804. Further, heavier cases 804 may be placed on the bottom of the stack of cases 804 while lighter cases 804 may be placed higher up.

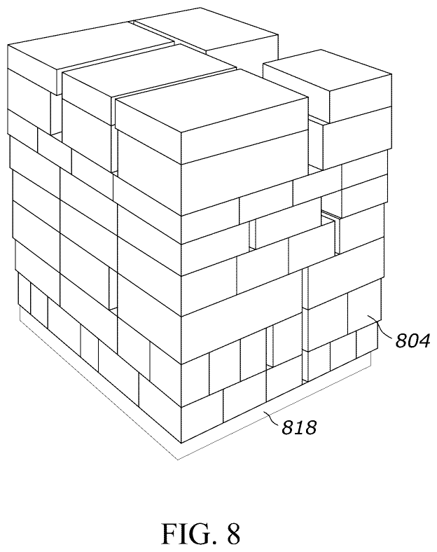

Referring now to FIG. 9, another example of a pallet 918 with multiple closed-top cases 904 is shown. Similarly to the FIG. 8, The cases 904 are placed in the sequence indicated by the numbering (e.g., 1, 2, 3, 4, 5, and so on) labeled on the cases 904. The sequencing may be determined by a selection and/or pallet building algorithm in order to increase stability of the cases 904 on the pallet 918. For example, cases 904 of similar heights may be placed next to one another in order to create an even row of cases 904. Further, heavier cases 904 may be placed on the bottom of the stack of cases 904 while lighter cases 904 may be placed higher up.

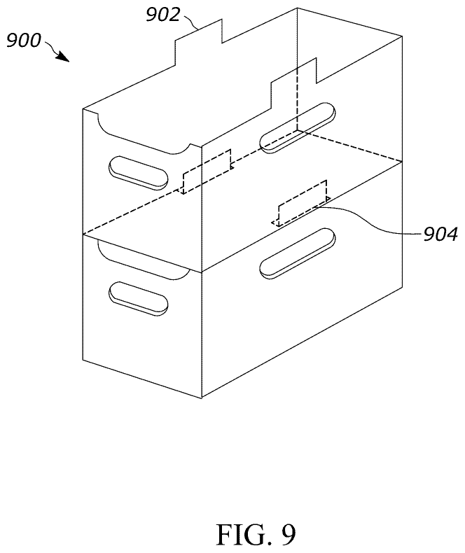

Referring now to FIG. 10, two open-top cases 1000 in alignment with one another are shown. Each open-top case 1000 includes tabs 1002 and corresponding alignment opening 1004 and/or slots. It is generally understood that the open-top cases 1000 are for example only, and that an open-top case 1000 may have any alternate number of tabs 1002 (e.g., 2, 4, 6, etc.) and corresponding alignment openings 1004 on the bottom of the open-top case 1000. The present embodiment includes openings/handles by which an open-top case 1000 may be picked up by, however, it is understood that alternate embodiments do not include openings/handles.

It is generally contemplated that the pallets 718, 818, 918 and the cases 704, 804, 904 may be the same and/or similar to the pallet 118 and the cases 104 of the system 100. Any of the approaches, processes, and methods described herein may result in the pallets and stacked cases described with reference to FIGS. 7, 8, 9, and 10.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a conveyor that moves cases, the cases containing consumer products, the cases including at least some open-top cases;
a robot having an arm, the robot being operated and controlled by a first control circuit;
a tool disposed at an end portion of the arm, the tool when actuated to remove the cases on the conveyor;
a sensor positioned to obtain sensed visual information about the cases that are located on the conveyor, wherein the sensor is operated and controlled by a second control circuit;
wherein the second control circuit:
receives the sensed visual information from the sensor;
processes the sensed visual information to obtain coordinates of a location on a case to contact the case such that damage to the case or contents of the case is prevented when the case is contacted by the tool at the location, wherein the location on a closed-top case comprises a top surface of the closed-top case, and wherein the location on an open-top case comprises a first location on a first side of the open-top case and a second location on a second side of the open-top case, the second side opposing the first side;
transforms the coordinates from a first frame of reference of the sensor to a second frame of reference of the robot; and
sends the transformed coordinates to the first control circuit instructing the robot to contact the case according to the coordinates;
wherein the first control circuit responsively controls the robot to precisely contact the case with the tool at the transformed coordinates and then to lift and move the case to a selected location on a pallet, the selected location on the pallet being determined by a selection algorithm so as to not damage the case or the contents of the case after the case is placed on the pallet.

2. The system of claim 1, wherein the second control circuit processes the sensed visual information by obtaining a three dimensional (3D) point cloud, converting the 3D point cloud into a depth map for a region of interest on the case that includes the case, performing image segmentation using the depth map to isolate the case, and determining contours of the case, a pose of the case, and dimensions of the case based upon the segmented image.

3. The system of claim 1, wherein subsequent to sending the transformed coordinates the robot sends an electronic acknowledgement to the sensor, which responsively causes the sensor to prepare to capture information concerning a next case on the conveyor.

4. The system of claim 1, wherein the selection algorithm determines locations for stacking based on alignment tabs and corresponding alignment openings of the cases.

5. The system of claim 4, wherein the selection algorithm utilizes a list of items to be included on the pallet, case dimensions, and case types to determine the selected location on the pallet.

6. The system of claim 5, wherein the selection algorithm determines an orientation of each case on the pallet, a position of each case on the pallet, and whether a slip sheet is required for the pallet.

7. The system of claim 1, wherein the sensor is a camera and the camera is a three dimensional (3D) vision camera.

8. The system of claim 1, wherein the second control circuit processes the sensed visual information by combining two dimensional (2D) red, green, blue (RGB) data and depth data.

9. The system of claim 1, wherein image segmentation is performed by the second control circuit using a segment anything model (SAM) algorithm.

10. The system of claim 1, wherein the coordinates are sent to the robot via Open Platform Communications Unified Architecture (OPC-UA) Protocol.

11. A method comprising:
moving cases using a conveyor, the cases containing consumer products, the cases including at least some open-top cases;
operating a robot using a first control circuit the robot having an arm and a tool disposed at an end portion of the arm, the tool when actuated to remove the cases on the conveyor;
obtaining sensed visual information about the cases that are located on the conveyor using a sensor, wherein the sensor is operated and controlled by a second control circuit;
at the second control circuit:
receiving the sensed visual information from the sensor;
processing the sensed visual information to obtain coordinates of a location on a case to contact the case such that damage to the case or contents of the case is prevented when the case is contacted at the location, wherein the location on a closed-top case comprises a top surface of the closed-top case, and wherein the location on an open-top case comprises a first location on a first side of the open-top case and a second location on a second side of the open-top case, the second side opposing the first side;
transforming the coordinates from a first frame of reference of the sensor to a second frame of reference of the robot; and
sending the transformed coordinates to the first control circuit instructing the robot to contact the case according to the coordinates;
wherein the first responsively controls the robot to precisely contact the case with the tool at the transformed coordinates and then to lift and move the case to a selected location on a pallet, the selected location on the pallet being determined by a selection algorithm so as to not damage the case or the contents of the case after the case is placed on the pallet.

12. The method of claim 11, wherein the second control circuit processes the sensed visual information by obtaining a three dimensional (3D) point cloud, converting the 3D point cloud into a depth map for a region of interest on the case that includes the case, performing image segmentation using the depth map to isolate the case, and determining contours of the case, a pose of the case, and dimensions of the case based upon the segmented image.

13. The method of claim 11, wherein subsequent to sending the transformed coordinates the robot sends an electronic acknowledgement to the sensor, which responsively causes the sensor to prepare to capture information concerning a next case on the conveyor.

14. The method of claim 11, wherein the selection algorithm determines locations for stacking based on alignment tabs and corresponding alignment openings of the cases.

15. The method of claim 14, wherein the selection algorithm utilizes a list of items to be included on the pallet, case dimensions, and case types to determine the selected location on the pallet.

16. The method of claim 15, wherein the selection algorithm determines an orientation of each case on the pallet, a position of each case on the pallet, and whether a slip sheet is required for the pallet.

17. The method of claim 11, wherein the sensor is a camera and the camera is a three dimensional (3D) vision camera.

18. The method of claim 11, wherein the second control circuit processes the sensed visual information by combining two dimensional (2D) red, green, blue (RGB) data and depth data.

19. The method of claim 11, wherein image segmentation is performed by the second control circuit using a segment anything model (SAM) algorithm.

20. The method of claim 11, wherein the coordinates are sent to the robot via Open Platform Communications Unified Architecture (OPC-UA) Protocol.
